(19) United States
(12) Patent Application Publication
(10) Pub. No.: US 2018/0014275 A1
(43) Pub. Date: Jan. 11, 2018

(54) MOBILE COMMUNICATION METHOD, NETWORK APPARATUS, AND BASE STATION

(71) Applicant: KYOCERA CORPORATION, Kyoto (JP)

(72) Inventors: Masato FUJISHIRO, Yokohama-shi (JP); Henry CHANG, San Diego, CA (US); Kugo MORITA, Higashiomi-shi (JP)

(73) Assignee: KYOCERA CORPORATION, Kyoto (JP)

(21) Appl. No.: 15/693,728

(22) Filed: Sep. 1, 2017

Related U.S. Application Data
(63) Continuation of application No. PCT/JP2016/056442, filed on Mar. 2, 2016.
(60) Provisional application No. 62/127,410, filed on Mar. 3, 2015.

(51) Int. Cl. H04W 68/02; H04W 8/06; H04W 36/08; H04W 76/04

(52) U.S. Cl. CPC H04W 68/02; H04W 76/048; H04W 8/06; H04W 36/08

(57) ABSTRACT

A network apparatus includes: a receiver configured to receive, from a base station, information relating to a cell on which a predetermined user terminal camps or a base station; a storage configured to store the information; and a controller configured to decide, based on the information, a base station to which a paging message is transmitted.

### RELATED APPLICATIONS

This application is a continuation application of international application PCT/JP2016/056442 (filed Mar. 2, 2016), which claims benefit of U.S. Provisional Application No. 62/127410 (filed on Mar. 3, 2015) is incorporated into the present specification by reference.

### TECHNICAL FIELD

The present application relates to a mobile communication method, a network apparatus, and a base station used in a mobile communication system.

### BACKGROUND ART

In 3GPP (3rd Generation Partnership Project), which is a project aiming to standardize a mobile communication system, a discontinuous reception (DRX) is prescribed as an intermittent reception technique to reduce power consumption of a radio terminal. A user terminal receives, in an idle state (for example, a state not in communication), a paging message (message for notifying an incoming call) transmitted from an MME, by using the above-mentioned DRX.

Here, the MME manages a location of each user terminal for each tracking area (TA) including a cell managed by one or more base stations (eNBs).

Therefore, when transmitting a paging message for a certain user terminal, the MME transmits the paging message to all base stations within a tracking area (TA) in which the user terminal is located, and all base stations that receive the paging message transmit the paging message.

In recent years, machine-type communication (MTC) in which a radio terminal performs communication without human intervention in a mobile communication system has attracted attention. From such a background, an ongoing discussion is a new introduction of an extended DRX (eDRX) cycle longer than a conventional DRX cycle to further reduce power consumption (for example, see Non Patent Document 1). The DRX using the extended DRX cycle is referred to as “extended DRX”.

### PRIOR ART DOCUMENT

### Non-Patent Document

Non Patent Document 1: 3GPP contribution “RP-141994”

### SUMMARY

A mobile communication method according to a first aspect comprising the steps of: associating, by a network apparatus, an identifier of a predetermined user terminal with an identifier of a cell on which the predetermined user terminal camps and/or an identifier of a base station managing the cell; and transmitting, by the network apparatus, a paging message addressed to the predetermined user terminal to a base station corresponding to the identifier of the cell or the identifier of the base station associated with the identifier of the predetermined user terminal.

A mobile communication method according to a second aspect comprises the steps of: storing, by a base station, an identifier of a predetermined user terminal camping on a cell managed by the base station; receiving, by the base station, a paging message from a network apparatus; determining, by the base station, whether an identifier of a user terminal included in the paging message matches the stored identifier of the predetermined user terminal; and transmitting, by the base station, the paging message in response to a determination that the identifier of the user terminal included in the paging message matches the stored identifier of the predetermined user terminal.

A network apparatus according to a third aspect comprises a controller including a processor and a memory communicatively coupled to the processor. The controller is configured to execute processes of: associating an identifier of a predetermined user terminal with an identifier of a cell on which the predetermined user terminal camps and/or a base station configured to manage the cell; and transmitting, a paging message addressed to the predetermined user terminal, to a base station corresponding to the identifier of the cell or the identifier of the base station associated with the identifier of the predetermined user terminal.

A base station according to a fourth aspect comprises a controller including a processor and a memory communicatively coupled to the processor. The controller is configured to execute processes of: receiving a paging message from a network apparatus; determining, based on an identifier of a user terminal included in the paging message, whether the user terminal camps on a cell managed by the base station; and rejecting transmission of the paging message, in response to a determination that the user terminal does not camp on a cell managed by the base station

A network apparatus according to a fifth aspect comprises a receiver configured to receive, from a base station, information on a base station or on a cell on which a predetermined user terminal camps; a storage configured to store the information; and a controller configured to decide, based on the information, a base station to which a paging message is transmitted.

### BRIEF DESCRIPTION OF THE DRAWINGS

FIG. 1 is a configuration diagram of an LTE system according to the present embodiment.

FIG. 2 is a block diagram of a UE according to the present embodiment.

FIG. 3 is a block diagram of an eNB according to the present embodiment.

FIG. 4 is a block diagram of an MME according to the present embodiment.

FIG. 5 is a protocol stack diagram according to the present embodiment.

FIG. 6 is a configuration diagram of a radio frame according to the present embodiment.

FIG. 7 is a diagram for describing an operation according to the present embodiment.

FIG. 8 is a diagram illustrating a sequence for describing an operation according to a first embodiment of the present embodiment.

FIG. 9 is a diagram illustrating an operation sequence according to an additional operation example 1 of the first embodiment of the present embodiment.

FIG. 10 is a diagram illustrating an operation sequence according to an additional operation example 2 of the first embodiment of the present embodiment.

FIG. 11 is a diagram illustrating an operation sequence according to an additional operation example 3 of the first embodiment of the present embodiment.

FIG. 12 is a diagram illustrating an operation sequence according to a second embodiment of the present embodiment.

FIG. 13 is a diagram illustrating an operation sequence according to an additional operation example of the second embodiment of the present embodiment.

### DESCRIPTION OF THE EMBODIMENT

### Overview of Embodiments

From the description in background art, it is concerned that if a terminal supporting machine-type communication (MTC) in which an extended DRX is configured in an idle state (for example, an M2M terminal such as a data communication module) is increased in the future, transmission of a paging message and resources used for the transmission are increased.

Thus, an embodiment provides a mobile communication method, a network apparatus, and a base station that enable the reduction of increase in the transmission of a paging message and the resources used for the transmission.

A mobile communication method according to the embodiments comprises the steps of; associating and storing, by a network apparatus, an identifier of a predetermined user terminal and an identifier of a cell on which the predetermined user terminal camps and/or an identifier of a base station managing the cell; and when transmitting a paging message addressed to the predetermined user terminal to a base station, transmitting, by the network apparatus, a paging message to a base station corresponding to the identifier of the cell or the identifier of the base station associated with the identifier of the predetermined user terminal.

In the embodiments, the predetermined user terminal is an extended DRX configured user terminal.

In the embodiments, the predetermined user terminal applies the extended DRX, based on extended DRX configuration information included in an RRC connection release message transmitted from the base station.

In the embodiments, when the predetermined user terminal performs cell reselection, the predetermined user terminal transmits, an identifier of a cell selected by the sell reselection and/or a base station managing the cell, to the network apparatus.

In the embodiments, the base station transmits, to the network apparatus, the identifier of the predetermined user terminal camping on a cell managed by the base station.

In the embodiments, the predetermined user terminal transmits the identifier of the user terminal to the base station.

In the embodiments, when the predetermined user terminal performs cell reselection, the predetermined user terminal transmits the identifier of the user terminal to a base station managing a cell selected by the cell reselection.

A mobile communication method according to the embodiments comprises the steps of; storing, by a base station, an identifier of a predetermined user terminal camping on a cell managed by the base station; and when the base station receives a paging message from a network apparatus and when an identifier of a user terminal included in the paging message matches the stored identifier of the predetermined user terminal, transmitting, by the base station, the paging message.

In the embodiments, the predetermined user terminal is an extended DRX configured user terminal.

In the embodiments, when the base station receives a paging message from the network apparatus and when the base station determines, based on an identifier of a user terminal included in the paging message, that the user terminal does not camp on a cell managed by the base station, the base station rejects transmission of the paging message.

In the embodiments, when the base station receives a paging message from the network apparatus and when an identifier of a user terminal included in the paging message does not match the stored identifier of the predetermined user terminal, the base station determines that the user terminal does not camp on a cell managed by the base station.

In the embodiments, the base station receives, from a neighboring base station, an identifier of a predetermined user terminal camping on a cell managed by the neighboring base station. When the identifier of the predetermined user terminal received from the neighboring base station and the identifier of the user terminal included in the paging message are matched to each other, the base station determines that the user terminal does not camp on a cell managed by the base station.

In the embodiments, when a user terminal performs cell reselection, the user terminal transmits an identifier of the user terminal to the neighboring base station configured to manage a cell selected by the cell reselection.

A network apparatus according to the embodiments associates and stores an identifier of a predetermined user terminal and an identifier of a cell on which the predetermined user terminal camps and/or a base station configured to manage the cell. When a paging message addressed to the predetermined user terminal is transmitted to a base station, the network apparatus transmits a paging message to a base station corresponding to the identifier of the cell or the identifier of the base station associated with the identifier of the predetermined user terminal.

A base station according to the embodiments rejects transmission of a paging message, when the paging message is received from a network apparatus and when the base station determines, based on an identifier of a user terminal included in the paging message, that the user terminal does not camp on a cell managed by the base station.

In the embodiments, the predetermined user terminal is a user terminal being stopped.

### Embodiments

Hereinafter, embodiments when the present disclosure is applied to an LTE system will be described.

### (System Configuration

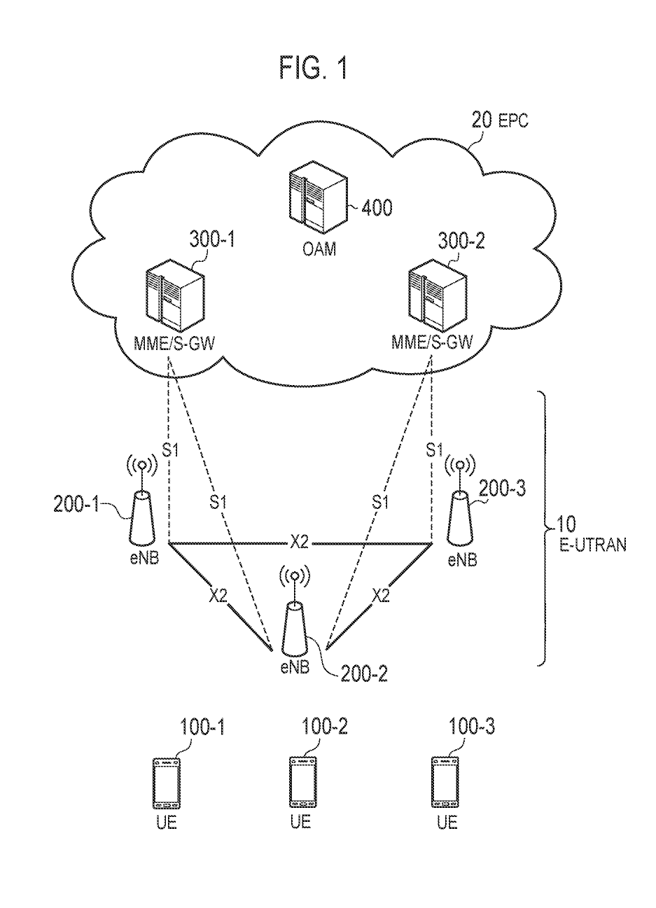

First, system configuration of the LTE system according to the embodiments will be described. FIG. 1 is a configuration diagram of an LTE system. As illustrated in FIG. 1, the LTE system according to embodiments includes a plurality of UEs (User Equipments) 100, E-UTRAN (Evolved-Universal Terrestrial Radio Access Network) 10, and EPC (Evolved Packet Core) 20.

The UE 100 corresponds to a user terminal. The UE 100 is a mobile communication device and performs radio communication with a cell (a serving cell) that connected to the radio terminal. Configuration of the UE 100 will be described later.

The E-UTRAN 10 corresponds to a radio access network. The E-UTRAN 10 includes a plurality of eNBs (evolved Node-Bs) 200. The eNB 200 corresponds to a base station. The eNBs200 are connected mutually via an X2 interface. Configuration of the eNB200 will be described later.

The eNB 200 manages one or a plurality of cells and performs radio communication with the UE 100 which establishes a connection with the cell of the eNB 200. The eNB 200 has a radio resource management (RRM) function, a routing function for user data, and a measurement control function for mobility control and scheduling, and the like. It is noted that the “cell” is used as a term indicating a minimum unit of a radio communication area, and is also used as a term indicating a function of performing radio communication with the UE 100.

The EPC 20 corresponds to a core network. The E-UTRAN 10 and the EPC 20 constitute a network (LTE network) of the LTE system. The EPC 20 includes a plurality of MME (Mobility Management Entity)/S-GWs (Serving-Gateways) 300 and a OAM (Operation and Maintenance) 400. The MME (network apparatus) performs various mobility controls and the like for the UE 100. The S-GW performs control to transfer user data. MME/S-GW 300 is connected to eNB 200 via an S1 interface.

The OAM 400 is a server apparatus managed by an operator, and performs maintenance and monitoring of the E-UTRAN 10.

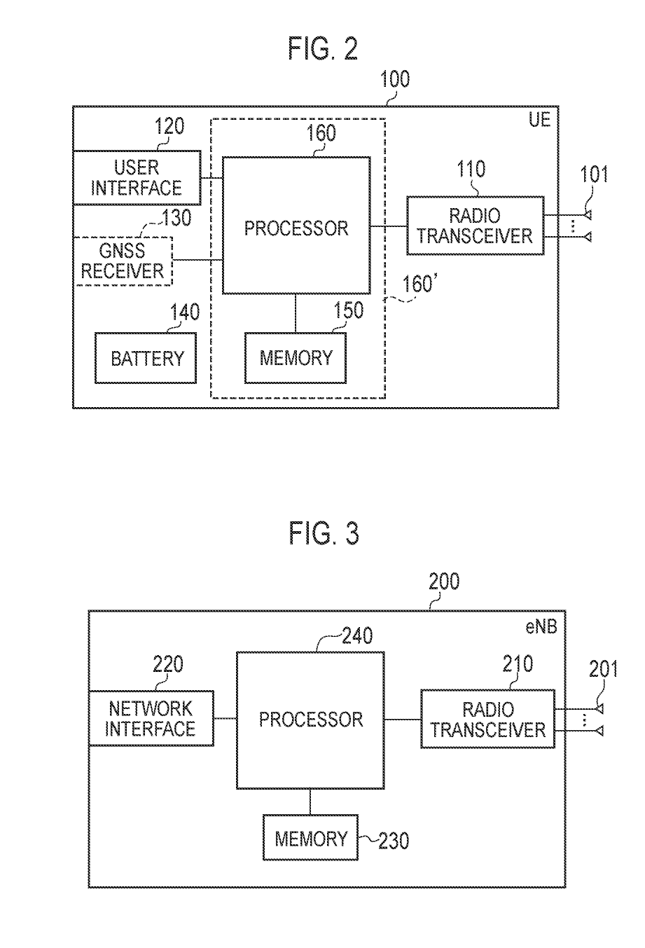

FIG. 2 is a block diagram of the UE 100. As illustrated in FIG. 2, the UE 100 includes plural antennas 101, a radio transceiver 110, a user interface 120, a GNSS (Global Navigation Satellite System) receiver 130, a battery 140, a memory 150, and a processor 160. The memory 150 corresponds a memory, the processor 160 corresponds to a controller. The UE 100 may not include the GNSS receiver 130. Furthermore, the memory 150 may be integrally formed with the processor 160, and this set (that is, a chip set) may be called a processor 160′.

The plural antennas 101 and the radio transceiver 110 are used to transmit and receive a radio signal. The radio transceiver 110 converts a baseband signal (a transmission signal) output from the processor 160 into the radio signal and transmits the radio signal from the antenna 101. Furthermore, the radio transceiver 110 converts a radio signal received by the antenna 101 into a baseband signal (a received signal), and outputs the baseband signal to the processor 160.

The user interface 120 is an interface with a user carrying the UE 100, and includes, for example, a display, a microphone, a speaker, various buttons and the like. The user interface 120 accepts an operation from a user and outputs a signal indicating the content of the operation to the processor 160. The GNSS receiver 130 receives a GNSS signal in order to obtain location information indicating a geographical location of the UE 100, and outputs the received signal to the processor 160. The battery 140 accumulates power to be supplied to each block of the UE 100.

The memory 150 stores a program to be executed by the processor 160 and information to be used for a process by the processor 160. The processor 160 includes a baseband processor that performs modulation and demodulation, encoding and decoding and the like on the baseband signal, and CPU (Central Processing Unit) that performs various processes by executing the program stored in the memory 150. The processor 160 may further include a codec that performs encoding and decoding on sound and video signals. The processor 160 executes various processes and various communication protocols described later.

Further, the UE 100 may include various sensors capable of determining whether the UE 100 is moving or stopped, such as a tilt sensor, an acceleration sensor, a gyro sensor, or the like.

FIG. 3 is a block diagram of the eNB 200. As illustrated in FIG. 3, the eNB 200 includes plural antennas 201, a radio transceiver 210, a network interface 220, a memory 230, and a processor 240. Furthermore, the memory 230 may be integrally formed with the processor 240, and this set (that is, a chip set) may be called a processor 240′. The plural antennas 201 and the radio transceiver 210 are used to transmit and receive a radio signal. The radio transceiver 210 converts a baseband signal (a transmission signal) output from the processor 240 into the radio signal and transmits the radio signal from the antenna 201. Furthermore, the radio transceiver 210 converts a radio signal received by the antenna 201 into a baseband signal (a received signal), and outputs the baseband signal to the processor 240.

The network interface 220 is connected to the neighboring eNB 200 via the X2 interface and is connected to the MME/S-GW 300 via the S1 interface. The network interface 220 is used in communication over the X2 interface and communication over the S1 interface.

The memory 230 stores a program to be executed by the processor 240 and information to be used for a process by the processor 240. The processor 240 includes a baseband processor that performs modulation and demodulation, encoding and decoding and the like on the baseband signal and CPU that performs various processes by executing the program stored in the memory 230. The processor 240 executes various processes and various communication protocols described later.

Further, the memory 230 may store, as a UE-ID list, the identifiers of the UEs located in the cell managed by the eNB 200 and setting extended DRX. The UE-ID list may include one or a plurality of UE identifiers.

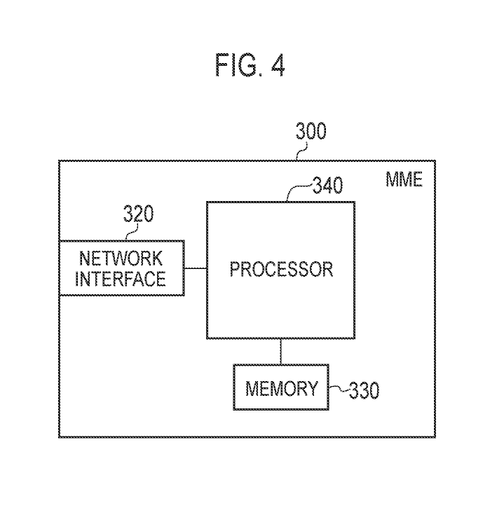

FIG. 4 is a block diagram of the MME 300. As illustrated in FIG. 4, the MME 300 includes a network interface 320, a memory 330, and a processor 340. The memory 330 may be integrated with the processor 340, and this set (that is, a chip set) may be called a processor.

The network interface 320 is connected to the eNB 200 via the S1 interface. The network interface 320 is used for communication performed on the S1 interface.

The memory 330 stores a program to be executed by the processor 340 and information to be used for a process by the processor 340. The processor 340 includes a baseband processor that performs modulation and demodulation, encoding and decoding and the like on the baseband signal, and CPU that performs various processes by executing the program stored in the memory 330. The processor 340 executes various processes and various communication protocols described later.

The memory 330 may store a UE/cell (eNB) list in which the identifier of the UE 100 setting the extended DRX, the identifier of the cell in which the UE 100 is located and/or the identifier of the eNB 200 managing the cell are associated with each other.

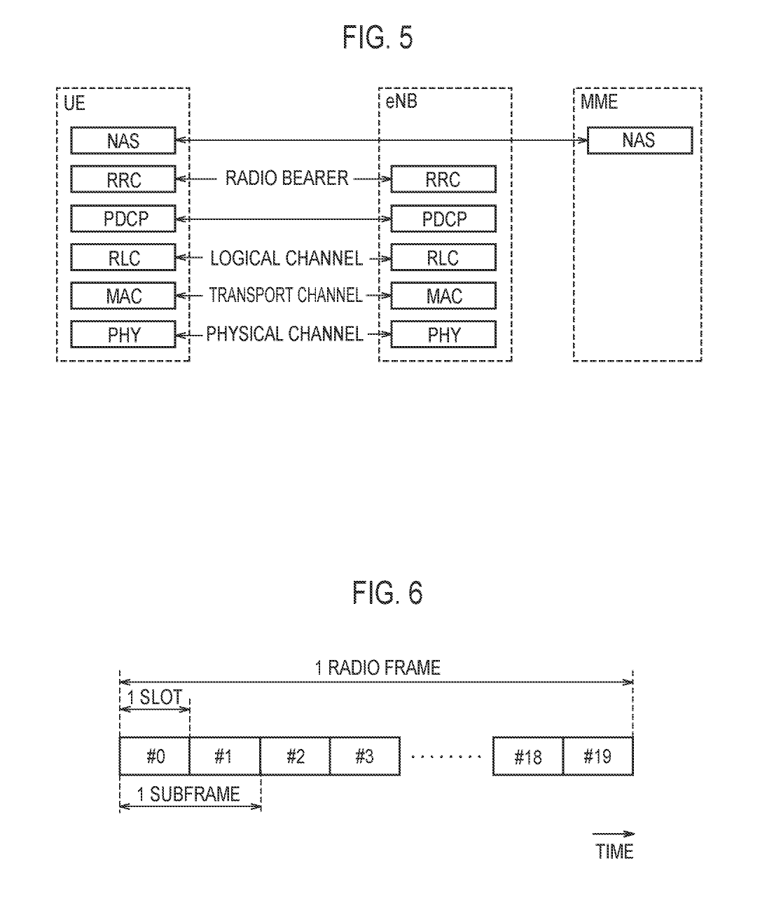

FIG. 5 is a protocol stack diagram of a radio interface in the LTE system. As illustrated in FIG. 5, the radio interface protocol is classified into a layer 1 to a layer 3 of an OSI reference model, wherein the layer 1 is a physical (PHY) layer. The layer 2 includes a MAC (Medium Access Control) layer, an RLC (Radio Link Control) layer, and a PDCP (Packet Data Convergence Protocol) layer. The layer 3 includes an RRC (Radio Resource Control) layer.

The PHY layer performs encoding and decoding, modulation and demodulation, antenna mapping and demapping, and resource mapping and demapping. Between the PHY layer of the UE 100 and the PHY layer of the eNB 200, user data and control signal are transmitted via the physical channel.

The MAC layer performs priority control of data, a retransmission process by hybrid ARQ (HARQ), and the like. Between the MAC layer of the UE 100 and the MAC layer of the eNB 200, user data and control signal are transmitted via a transport channel. The MAC layer of the eNB 200 includes a scheduler that determines (schedules) a transport format of an uplink and a downlink (a transport block size and a modulation and coding scheme (MCS)) and a resource block to be assigned to the UE 100.

The RLC layer transmits data to an RLC layer of a reception side by using the functions of the MAC layer and the PHY layer. Between the RLC layer of the UE 100 and the RLC layer of the eNB 200, user data and control signal are transmitted via a logical channel.

The PDCP layer performs header compression and decompression, and encryption and decryption.

The RRC layer is defined only in a control plane dealing with control signal. Between the RRC layer of the UE 100 and the RRC layer of the eNB 200, control signal (RRC messages) for various types of configuration are transmitted. The RRC layer controls the logical channel, the transport channel, and the physical channel in response to establishment, re-establishment, and release of a radio bearer. When there is a connection (RRC connection) between the RRC of the UE 100 and the RRC of the eNB 200, the UE 100 is in an RRC connected mode (connected mode), otherwise the UE 100 is in an RRC idle mode (idle mode).

A NAS (Non-Access Stratum) layer positioned above the RRC layer performs a session management, a mobility management and the like. The RRC layer, the PDCP layer, the RLC layer, the MAC layer, and the PHY layer are collectively referred to as an AS (Access Stratum) layer.

FIG. 6 is a configuration diagram of a radio frame used in the LTE system. In the LTE system, OFDMA (Orthogonal Frequency Division Multiplexing Access) is applied to a downlink (DL), and SC-FDMA (Single Carrier Frequency Division Multiple Access) is applied to an uplink (UL), respectively.

As illustrated in FIG. 6, a radio frame is configured by 10 subframes arranged in a time direction. Each subframe is configured by two slots arranged in the time direction. Each subframe has a length of 1 ms and each slot has a length of 0.5 ms. Each subframe includes a plurality of resource blocks (RBs) in a frequency direction (not shown), and a plurality of symbols in the time direction. Each resource block includes a plurality of subcarriers in the frequency direction. One symbol and one subcarrier forms one resource element (RE). Of the radio resources (time and frequency resources) assigned to the UE 100, a frequency resource can be constituted by a resource block and a time resource can be constituted by a subframe (or a slot).

### Operation According to Embodiment

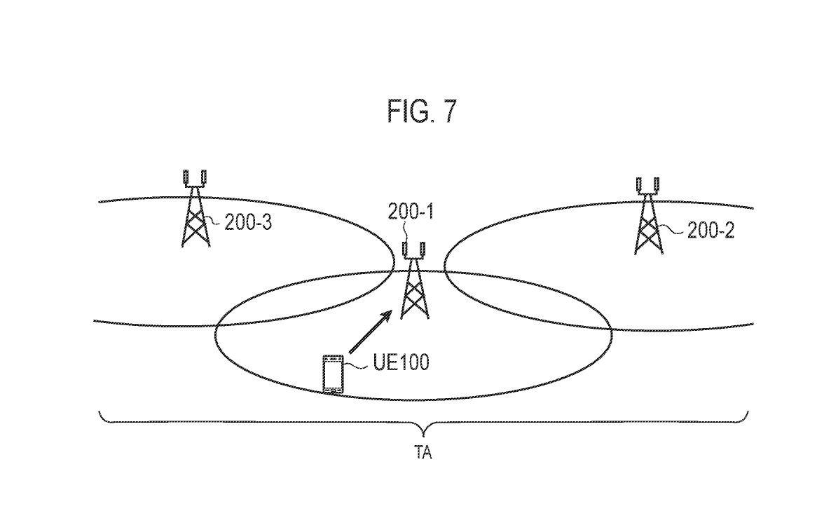

An operation according to the present embodiment will be described by using FIG. 7.

As illustrated in FIG. 7, the UE 100 camps on a cell managed by an eNB 200-1.

Each of the eNB 200-1, an eNB 200-2, and an eNB 200-3 manages cells, and each of the cells belongs to the same tracking area (TA). Each of the eNBs 200 is connected to the MME 300 via the S1 interface.

The MME 300 grasps, by location registration of the UE 100, a tracking area in which the UE 100 is located. Specifically, for example, the MME 300 associates the UE 100 with the tracking area in which the UE 100 is located, and stores the association in the memory 330.

Hereinafter, the eNB 200-3 performs an operation similar to that of the eNB 200-2, and thus the description of the eNB 200-3 will be omitted.

### First Embodiment

An operation according to the first embodiment will be described, below. The MME 300 grasp an extended DRX configured UE 100, and a cell on which the UE 100 camps and/or the eNB 200 (200-1) managing the cell. Specifically, for example, the MME 300 stores, in the memory 330, a UE/cell (eNB) list in which an identifier of the extended DRX configured UE 100 and an identifier of the cell on which the UE 100 camps and/or an identifier of the eNB 200 (200-1) managing the cell are associated. It is noted that the acquisition of the identifier of the UE 100 and the identifier of the cell on which the UE 100 camps and/or the identifier of the eNB 200 managing the cell included in the list, and the preparation and update (including removal etc.) of the UE/cell (eNB) list may be realized by at least any one of additional operation examples 1 to 3 described later, for example. It is noted that the identifier of the UE 100 is, for example, an IMSI (International Mobile Subscriber Identity), a TMSI (Temporary Mobile Subscriber Identity), or a UE ID. It is noted that the UE ID may be a UE SlAP ID (eNB UES1 AP ID or MME UE S1 AP ID). Furthermore, the identifier of a cell is a cell ID, for example. It is noted that the cell ID may be an ECGI (E-UTRAN Cell Global ID) or an ECI (E-UTRAN Cell Identifier). It is noted that the ECGI is PLMN ID+ECI, and the ECI is eNB ID+cell ID. Furthermore, the identifier of the eNB 200 is an eNB ID, for example.

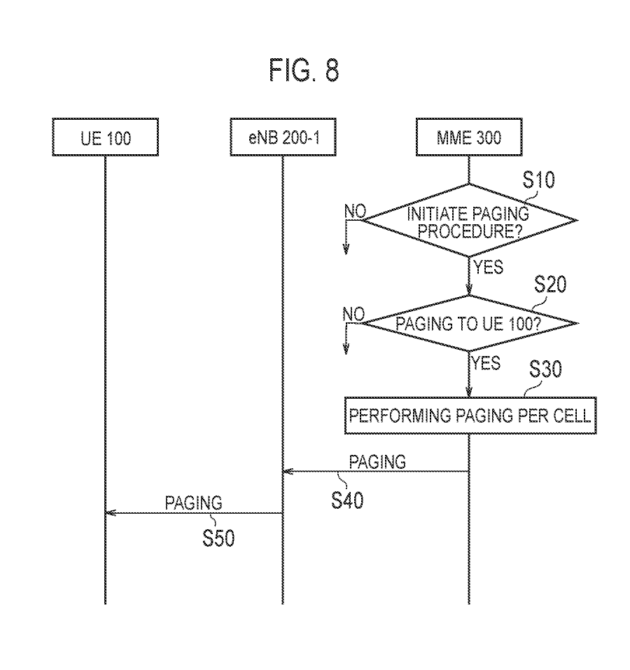

Next, the operation according to the first embodiment will be described by using FIG. 8. FIG. 8 is a sequence diagram for describing the operation according to the first embodiment.

As illustrated in FIG. 8, firstly in step S10, the MME 300 determines whether or not to initiate a paging procedure (S10). Here, if the paging procedure is not initiated (S10 NO), the MME 300 waits until the paging procedure is initiated.

Next, if the paging procedure is initiated (S10 YES), the MME 300 determines whether a paging message to be transmitted through the paging procedure is a paging message for the extended DRX configured UE 100 (paging message addressed to the UE 100) (S20). Specifically, the MME 300 determines whether or not it is the paging message for the extended DRX configured UE 100, based on whether or not the identifier of the UE included in a paging message to be transmitted matches the identifier of the UE 100 in the aforementioned UE/cell (eNB) list. It is noted that the paging message is a paging message transmitted from the MME 300 through the eNB 200 to the UE 100 via the S1 interface, prescribed in the 3GPP, for example.

Next, if the MME 300 determines that the paging message to be transmitted is the paging message for the extended DRX configured UE 100 (S20 YES), the MME 300 determines to perform Per-cell Paging (S30). Here, “Per-cell Paging” refers to a procedure of transmitting by the MME 300, a paging message to only the eNB 200-1 managing the cell on which the UE 100 camps. In other words, in the Per-cell Paging, the MME 300 does not transmit a paging message or prohibits the transmission of a paging message to the eNBs 200 (200-2 and 200-3) that are in the tracking area in which the UE 100 is located and are other than the eNB 200-1 managing the cell on which the UE 100 camps.

Moreover, if the MME 300 determines to perform the Per-cell Paging in S30, the MME 300 decides the eNB 200-1 as a destination to which the paging message is transmitted, by based on the UE/cell (eNB) list stored in the memory 330, determining that an identifier of a cell associated with the identifier of the UE 100 is the cell managed by the eNB 200-1 or determining that the identifier of the eNB 200 associated with the identifier of the UE 100 is the identifier of the eNB 200-1.

Meanwhile, if the MME 300 determines, in S20, that the paging message to be transmitted through the paging procedure is not for the extended DRX configured UE 100 (S20, NO), the MME 300 determines to perform normal paging. Specifically, the MME 300 determines to perform the normal paging if the identifier of the UE included in the paging message to be transmitted does not match the identifier of the UE 100 in the UE/cell (eNB) list stored in the memory 330. Here, the “normal paging” refers to a procedure of conventionally transmitting, by the MME 300, a paging message to all of the eNBs 200 (200-1 to 200-3) within the tracking area in which the UE is located.

Next, if, in S20, the MME 300 decides the eNB 200-1 as a destination to which the paging is transmitted, the MME 300 transmits a paging message to only the eNB 200-1 managing the cell on which the UE 100 camps (S40), and does not transmit a paging message to other eNBs (200-2, 200-3) within the tracking area in which the UE 100 is located.

Next, the eNB 200-1 that has received the paging message transmitted from the MME 300 in S40 transmits the paging message (S50). It is noted that for the transmission of the paging message by the eNB 200-1 in S50, a method conventionally used for the transmission of the paging message by the eNB 200 is employed.

It is noted that the eNB 200-1 may store, in the memory 230, the identifier of the extended DRX configured UE 100 camping on the cell managed by the eNB 200-1 by associating with the identifier of the cell. In this case, even if a cell of the destination is not specified in the paging message transmitted from the MME 300, the eNB 200-1 may specify the identifier of the cell associated with the UE 100 in the memory 230, and transmit a paging message only to the cell.

According to the first embodiment, the eNBs 200-2 and 200-3 that are in the tracking area in which the extended DRX configured UE 100 is located and that manages cells on which the UE 100 does not actually camp, will not transmit a paging message for the UE 100, and thus, saving of resources and reduction of process load of the eNB can be achieved. Furthermore, the MME 300 also will not transmit a paging message to the eNBs 200-2 and 200-3, and thus, the saving of resources and reduction of process load of the MME can be also realized.

Next, additional operation examples 1 to 3 of the first embodiment will be described. As described above, the additional operation examples 1 to 3 described below are operations to realize the acquisition and update (including removal etc.) of the UE/cell (eNB) list stored in the memory of the MME 300 in the first embodiment.

### Additional Operation Example 1

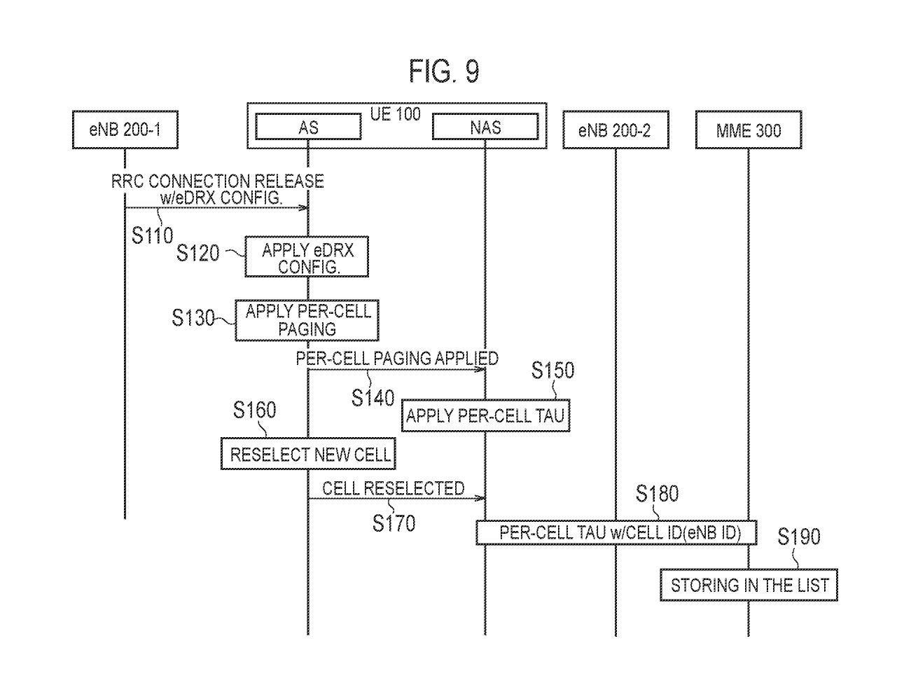

An additional operation example 1 of the first embodiment will be described by using FIG. 9. FIG. 9 is a diagram illustrating an operation sequence according to the additional operation example 1 of the first embodiment.

First, if the UE 100 camps on the cell managed by the eNB 200-1 as illustrated in FIG. 7, the eNB 200-1 transmits, to the UE 100, an RRC connection release message (RRC Connection Release) including extended DRX configuration information, when releasing an RRC connection with the UE 100 (S110). If the RRC Connection Release transmitted from the eNB 200-1 is received in an AS layer, the UE 100 transitions from an RRC connected state to an RRC idle state. Furthermore, at the same time of the transition to the RRC idle state, the UE 100 applies the extended DRX, based on the extended DRX configuration information included in the received RRC Connection Release (S120). The extended DRX configuration information includes information relating to an interval (cycle) during which the UE 100 is in standby for the paging message, for example. The extended DRX configured UE 100 activates the radio transceiver 110 at the interval (cycle), and monitors the paging message transmitted from the eNB 200-1.

Next, upon application of the extended DRX configuration (or reception of the RRC Connection Release including the extended DRX configuration information) in S120, the UE 100 applies the Per-cell Paging in the AS layer (S130).

Next, the UE 100 notifies a NAS layer (upper layer) that the Per-cell Paging is applied in the AS layer (Per-cell Paging applied) (S140). Here, when notification is made from the AS layer to the NAS layer, the UE 100 may notify the fact that the Per-cell Paging is applied as a Release Cause. It is noted that the UE 100 may not need to apply the Per-cell Paging in S130, and in this case, instead of notifying the NAS layer of the fact that the Per-cell Paging is applied in S140, the UE 100 may notify the NAS layer of the fact that the extended DRX configuration is applied or Per-cell TAU (Tracking Area Update) should be applied.

Next, in response to the notification that the Per-cell Paging from the AS layer is applied (or the notification that the extended DRX configuration is applied or the Per-cell TAU should be applied) in S140, the UE 100 applies a Per-cell TAU procedure in the NAS layer (S150). The Per-cell TAU procedure is, unlike a normal TAU procedure, a TAU procedure to be performed upon selection of a new cell by cell reselection etc., and the procedure includes: transmitting, to the MME 300, TAU (or a TAU Request) including an identifier of the reselected new cell and/or an identifier of the eNB 200 managing the cell. It is noted that even if the Per-cell TAU is applied, the UE 100 may be in a state in which the normal TAU in the TA unit is also applied.

Next, if the UE 100 moves from an area of the current cell (cell managed by the eNB 200-1) to an area of another cell (cell managed by the eNB 200-2), the UE 100 reselects a new cell (cell managed by the eNB 200-2) by performing cell reselection in the AS layer (S160).

Next, the UE 100 notifies, from the AS layer (lower layer) to the NAS layer (upper layer), the fact that the cell reselection is performed (or a new cell is selected) (S170).

Next, upon reception of the notification from the AS layer in S170, the UE 100 performs the Per-cell TAU procedure in the NAS layer (S180). Specifically, the UE 100 transmits, in the NAS layer, the Per-cell TAU to the MME 300. This Per-cell TAU includes an identifier of the newly selected cell and/or an identifier of the eNB 200-2 managing the cell. Furthermore, this Per-cell TAU may include the identifier of the UE 100. It is noted that the Per-cell TAU may be a conventional TAU (or TAU Request), or may be another message (for example, Per Cell TAU or Per Cell TAU Request).

Next, upon reception of the Per-cell TAU transmitted from the UE 100 in S180, the MME 300 newly stores, in the UE/cell (eNB) list in the memory 330, an identifier of a cell included in the Per-cell TAU and/or the identifier of the eNB 200-2 by associating with the identifier of the UE 100 (S190). Here, if the UE/cell (eNB) list is not stored in the memory 330, the MME 300 newly prepares a UE/cell (eNB) list and stores the identifiers.

Therefore, even if the extended DRX configured UE 100 moves to (reselects) a different cell within the same tracking area, the UE 100 performs the TAU (Per-cell TAU), and thus, the MME 300 can grasp that to which cell (or the eNB 200-2) the UE 100 moves (reselects). As a result, when transmitting a paging message for the UE 100 after the UE 100 moves, the MME 300 can transmit a paging message to only the eNB 200-2 managing a cell on which the UE 100 currently camps.

It is noted that in S110, if the eNB 200-1 transmits, to the UE 100, the RRC Connection Release including the extended DRX configuration information, the extended DRX configuration information may be transmitted to the MME 300. This extended DRX configuration information may be included in a conventional 51 UE CONTEXT RELEASE REQUEST or UE CONTEXT RELEASE COMMAND. Furthermore, this extended DRX configuration information may include a paging period in the extended DRX. Here, the paging period refers to an interval during which the radio transceiver 110 of the UE 100 is activated, for example. The paging period is set between 1 and 3600 minutes, for example.

Furthermore, if the conventional S1 UE CONTEXT RELEASE REQUEST or UE CONTEXT RELEASE COMMAND including the extended DRX configuration information is received, the MME 300 may perform the following operations.

(1) The MME 300 sets the paging period as a holding period for the paging message. It is noted that the MME 300 may notify the S-GW 300 of the holding period, for each UE 100. Furthermore, the S-GW 300 may remove, from the memory (buffer), information of the UE 100 (extended DRX configuration information) that cannot be transferred even after the holding period. It is noted that the MME 300 having the holding period for the paging message being expired, may discard the paging message. Furthermore, if the paging message is discarded, the MME 300 may notify the S-GW 300 of the discard, for each UE 100. If the notification is received, the S-GW 300 may remove the information of the UE (extended DRX configuration information) from the memory (buffer).

(2) A Mobile Reachable Timer (timer for regularly performing the TAU to grasp the situation of communication availability) is set to a value equal to the paging period or a value equal to or above the paging period.

### Additional Operation Example 2

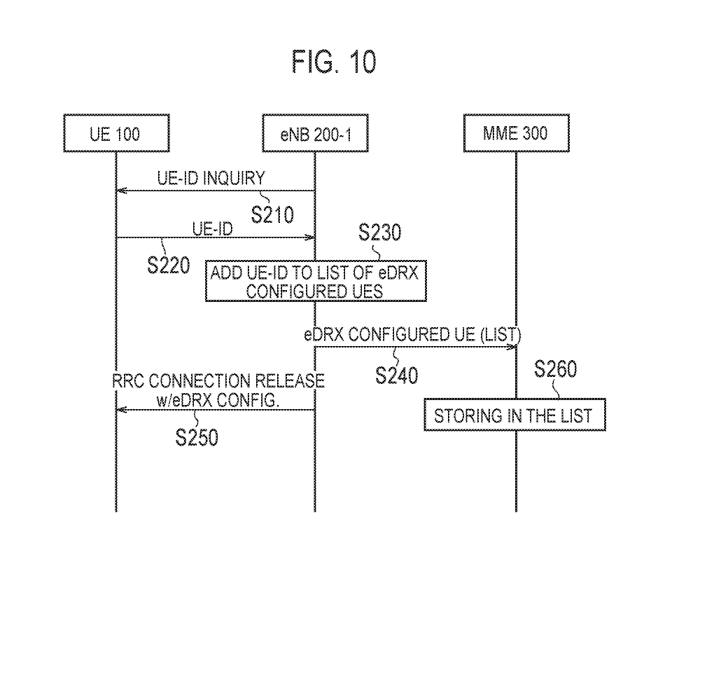

Next, an additional operation example 2 according to the first embodiment will be described by using FIG. 10. FIG. 10 is a diagram illustrating an operation sequence according to the additional operation example 2 of the first embodiment.

Firstly, if the UE 100 is located in the cell managed by the eNB 200-1 as illustrated in FIG. 7, the eNB 200-1 transmits, to the UE 100, a message for requesting the identifier of the UE 100 (for example, UE-ID Inquiry), before transmitting, to the UE 100, an RRC connection release message (RRC Connection Release) to release the RRC connection with the UE 100 in the RRC connected state (S210).

Next, the UE 100 that has received the message for requesting the identifier of the UE 100 from the eNB 200-1 transmits the identifier of the UE 100 to the eNB 200-1 (S220). It is noted that the UE 100 may transmit the identifier of the UE 100 to the eNB 200-1 and transmit the identifier of the cell on which the UE 100 camps to the eNB 200.

Here, the eNB 200-1 adds and stores, in the UE-ID list in the memory 230, the identifier of the UE 100 received from the UE 100 as the extended DRX configured UE (UE scheduled to be extended-DRX-configured) (S230). It is noted that if the identifier of the cell is received together with the identifier of the UE 100 from the UE 100, the eNB 200 may add and store, in the UE-ID list, the identifier of the cell by associating with the identifier of the UE 100. Furthermore, if the UE-ID list is not yet stored (prepared) in the memory 230, the eNB 200-1 may newly prepare a UE-ID list, and register and store, in the UE-ID list, the identifier of the UE 100 received from the UE 100. Moreover, the eNB 200-1 may associate and store, in the memory 230, the identifier of the UE 100 received from the UE 100 and a C-RNTI assigned to the UE 100.

Next, the eNB 200-1 transmits, to the MME 300, the list in which the identifier of the UE 100 (and the identifier of the cell on which the UE 100 camps) is newly added (S240). At this time, in addition to the transmission of the list, the eNB 200-1 may transmit the identifier of the eNB 200-1 to the MME 300. Furthermore, instead of transmitting the list, the eNB 200-1 may transmit only the identifier of the UE 100 received from the UE 100.

Next, the eNB 200-1 transmits, to the UE 100, an RRC Connection Release including the extended DRX configuration information, to release the RRC connection with the UE 100 and configure the extended DRX in the UE 100 (S250). In response to this, the UE 100 releases the RRC connection with the eNB 200-1 (transitions from the RRC connected state to the RRC idle state) and configures the extended DRX, based on the received extended DRX configuration information (S250). Then, the UE 100 intermittently monitors, based on the extended DRX configuration, a paging message regularly transmitted from the eNB 200-1.

Meanwhile, the MME 300 that has received the list transmitted from the eNB 200-1 in S240 updates the list in the memory 330, based on the received list. Specifically, the identifier of the UE 100 included in the list transmitted from the eNB 200 is associated with the identifier of the eNB 200-1 and/or the cell on which the UE 100 camps, and is added and stored in the list stored in the memory 330 (S260). Alternatively, if the list in which the identifier of the extended DRX configured UE is associated with the cell on which the UE camps and/or the eNB 200 managing the cell is not stored in the memory 330, the MME 300 may newly prepare and store a list in which the identifier of the UE included in the list transmitted from the eNB 200 is associated with the identifier of the eNB 200-1. In this case, the MME 300 may transition to a state capable of performing the Per-cell Paging, upon new preparation of the list in the memory 330.

Upon being in this state, in S20 in the first embodiment, the MME 300 may initiate determination whether it is a paging message for the extended DRX configured UE 100.

According to the additional operation example 2, the MME 300 can grasp the identifier of the extended DRX configured UE 100 and the cell on which the UE 100 camps and/or the eNB 200 managing the cell, at a timing at which the UE 100 applies the extended DRX configuration.

It is noted that the order of S240 and S250 in the additional operation example 2 may be reversed.

### Additional Operation Example 3

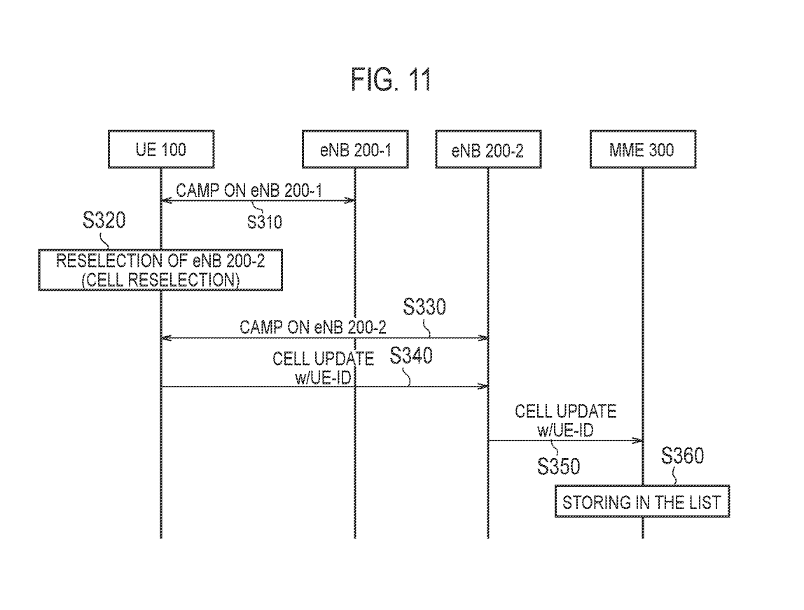

Next, an additional operation example 3 according to the first embodiment will be described by using FIG. 11. FIG. 11 is a diagram illustrating an operation sequence according to the additional operation example 3 in the first embodiment. The additional operation example 3 is, for example, an operation performed if the UE 100 moves from an area of the cell managed by the eNB 200-1 to an area of the cell managed by the eNB 200-2, after the aforementioned additional operation example 2 is performed.

First, in step S310, the UE 100 is in a state in which the UE 100 applies to the extended DRX in the RRC idle state and intermittently monitors the paging message transmitted from the eNB 200-1 (S310).

Next, if the UE 100 moves from the area of the current cell (cell managed by the eNB 200-1) to the area of another cell (cell managed by the eNB 200-2), the UE 100 reselects a new cell (cell managed by the eNB 200-2) by performing cell reselection (S320).

As a result, the UE 100 will be in a state of intermittently monitoring, in the RRC idle state, the paging message transmitted from the cell managed by the eNB 200-2 (state of standby for the cell managed by the eNB 200-2) (S330). Here, upon being standby for the cell managed by the eNB 200-2, the UE 100 may invalidate the extended DRX configuration based on the extended DRX configuration information received from the cell managed by the eNB 200-1 or discard the extended DRX configuration information.

Next, the UE 100 performs an RRC connection with the eNB 200-2 (transitions from the RRC idle state to the RRC connected state) by performing an RRC connection procedure (preforming transmission of an RRC Connection Request, etc.) with the eNB 200-2.

Next, the UE 100 transmits, to the eNB 200-2 in the RRC connection, a Cell Update message including the identifier of the UE 100 (for example, the UE-ID) (S340). It is noted that, instead of transmitting the Cell Update message, the UE 100 may transmit another message (for example, an eNB Update message) including the identifier of the UE 100 (for example, the UE-ID). It is noted that, instead of upon being standby for the eNB 200-2, upon transmission of the Cell Update message (or upon performing the RRC connection with the eNB 200-2), the UE 100 may invalidate the extended DRX configuration based on the extended DRX configuration information received from the cell managed by the eNB 200-1 or discard the extended DRX configuration information.

Next, the eNB 200-2 transmits, to the MME 300, the Cell Update message including the identifier of the UE 100 received from the UE 100 (S350).

The MME 300 that has received the Cell Update message updates the list stored in the memory 330. Specifically, the MME 300 removes, from the list, the identifier of the UE 100 included in the Cell Update message. In addition, the MME 300 may also remove the identifier of the cell on which the UE 100 camps and/or the identifier of the eNB 200 managing the cell that is stored in the list by associating with the identifier of the UE 100.

As a result, the MME 300 can more accurately grasp a UE applied with the extended DRX configuration, and appropriately realize the Per-cell Paging.

### Second Embodiment

An operation according to the second embodiment will be described, below.

In the second embodiment, similarly to the first embodiment, the MME 300 grasps, by the location registration of the UE 100, a tracking area in which the UE 100 is located. Specifically, for example, the MME 300 associates the UE 100 with the tracking area in which the UE 100 is located, and stores the association in the memory 330.

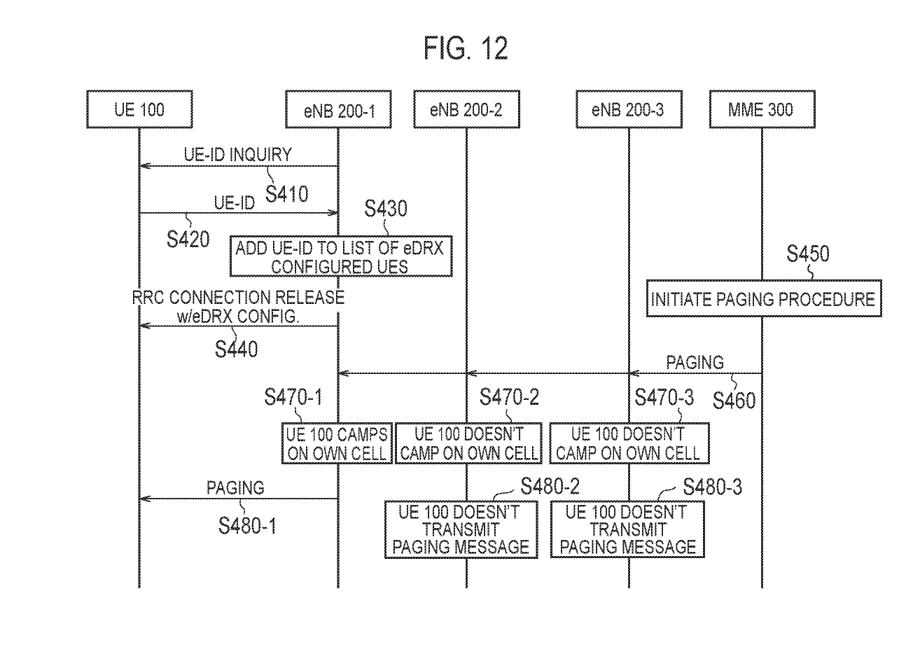

Meanwhile, in the second embodiment, unlike in the first embodiment, the MME 300 does not grasp that on which cell (or the eNB 200) the extended DRX configured UE 100 camps. Instead, each of the eNBs 200 (200-1 to 200-3) grasps a UE 100 that camps on the cell managed by the eNB 200 and is applied with the extended DRX. Specifically, each of the eNBs 200 acquires the identifier of the UE 100 (for example, the UE-ID) that camps on the cell managed by the eNB 200 and is applied with the extended DRX, by using a method etc. described later, and stores the identifier as the UE-ID list in the memory 230. As a result, the MME 300 can perform the paging procedure for each tracking area as in the conventional manner, and each of the eNBs 200 that have received the paging message can achieve the Per-cell Paging in accordance with the identifier of the UE 100 stored in the memory 230. Details thereof will be described by using FIG. 12, below. FIG. 12 is a diagram illustrating an operation sequence according to the embodiment.

S410 to S440 in FIG. 12 correspond to S210 to S230 and S250 in FIG. 10, respectively.

Next, in step S450, the MME 300 determines to initiate the paging procedure. As a trigger for initiating the paging procedure at this time, event occurrence that is conventionally used as a trigger for initiating the paging procedure may be employed.

Next, the MME 300 conventionally transmits a paging message for the UE 100 (paging message addressed to the UE 100), to all of the eNBs 200 (200-1 to 200-3) within the tracking area in which the UE 100 is located (S460).

Next, the eNB 200-1 that has received the paging message for the UE 100 from the MME 300 determines that the UE 100 camps on the cell managed by the eNB 200-1 (S470-1), and transmits the paging message. Specifically, the eNB 200-1 determines that the UE 100 camps on the cell managed by the eNB 200-1, by determining that the identifier of the UE included in the UE ID list stored in the memory 230 matches the identifier of the UE 100 included in the paging message.

Meanwhile, the eNB 200-2 that has received the paging message for the UE 100 from the MME 300, like the eNB 200-1, determines that the UE 100 does not camp on the cell managed by the eNB 200-2 (S470-2), and does not transmit the paging message or prohibits (rejects) the transmission of the paging message (S480-2). Specifically, the eNB 200-2 determines that the UE 100 does not camp on the cell managed by the eNB 200-2, by determining that the identifier of the UE in the UE-ID list does not match the identifier of the UE 100 included in the paging message since the identifier of the UE 100 is not included in the UE-ID list (list including the identifier of the UE that camps on the cell managed by the eNB 200 and is applied with the extended DRX) in the memory of the eNB 200-2 due to the identifier of the UE 100 being not received from the UE 100, and the like. Similarly to the eNB 200-2, the eNB 200-3 also determines that the UE 100 does not camp on the cell managed by the eNB 200-3 (S470-3), and does not transmit the paging message received from the MME 300 or prohibits (rejects) the transmission of the paging message (S480- 3).

Furthermore, the eNB 200-1 may transmit the identifier of the UE 100 received from the UE 100 in S420 to another eNB 200 (200-2 and 200-3) located in (belonging to) the same tracking area. As a result, the eNBs 200-2 and 200-3 can recognize that the extended DRX configured UE 100 camps on the cell managed by the eNB 200-1, and thus, can grasp that the extended DRX configured UE 100 does not camp on the cells managed by the eNBs 200-2 and 200-3.

Therefore, the eNB 200-2 (200-3) may determine that the UE 100 does not camp on the cell managed by the eNB 200-2 (200-3), by, in S470-2 (S470-3), determining that the identifier of the UE 100 received from the eNB 200-1 matches the identifier of the UE 100 included in the paging message, instead of using the UE-ID list stored in the memory by the eNB 200-2 (200-3).

Furthermore, the eNB 200-2 (200-3) may remove the identifier of the UE 100 from the UE-ID list, if the identifier of the UE matching the identifier of the UE 100 received from the eNB 200-1 is included in the UE-ID list stored in the memory of the eNB 200-2 (200-3).

As a result, the eNB 200-2 (200-3) can more accurately grasp a UE camping on the cell managed by the eNB 200-2 (200⁻3).

### Additional Operation Example

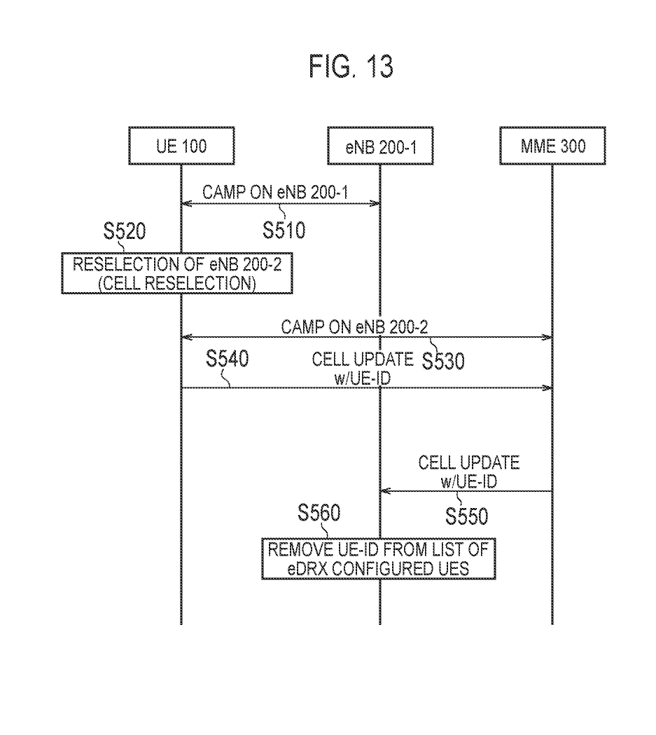

An additional operation example of the second embodiment will be described by using FIG. 13. FIG. 13 is a diagram illustrating an operation sequence according to the additional operation example of the second embodiment.

S510 to S540 in FIG. 13 correspond to S310 to S340 in the additional operation example 3 of the first embodiment in FIG. 11.

Upon reception of a Cell Update message from the UE 100 in S540, the eNB 200-2 transmits the Cell Update message to the eNB 200-1 (S550). The Cell Update messages in S540 and S550 include an identifier of the UE 100 that newly camps on the eNB 200-2. It is noted that the Cell Update message in S540 and the Cell Update message in S550 may be the same, or may be partially different.

Next, the eNB 200-1 updates the UE ID list by removing, from the UE-ID list stored in the memory 230 of the eNB 200-1, the identifier of the UE 100 included in the Cell Update message received from the eNB 200-2 (S560). As a result, even if the UE performs cell reselection, the eNB 200 can accurately grasp a UE that camps on the cell managed by the eNB 200 and is applied with the extended DRX, and can more appropriately determine whether or not to transmit the paging message.

Furthermore, the eNB 200-1 may separately store the identifier of the UE 100 included in the Cell Update message received from the eNB 200-2, without using the identifier for updating the UE ID list. Thus, the eNB 200-1 may use the separately stored identifier of the UE 100 to determine whether or not to transmit the paging message by determining whether or not the separately stored identifier matches the identifier of the UE included in the paging message.

It is noted that the UE 100 may notify the cell on which the UE camps (and/or the eNB 200 managing the cell) of UE Assistance Information including the fact that the UE 100 is moving or stopped. Here, the UE 100 may determine whether or not the UE 100 is moving or stopped, by using various sensors incorporated in the UE 100.

Here, if the eNB 200 receives, from the UE 100, the UE Assistance Information including the fact that the UE 100 is moving or stopped, the eNB 200 determines whether or not to include the extended DRX configuration information into an RRC Connection Release to be transmitted to the UE 100, in accordance with whether the UE 100 is moving or stopped. For example, if the eNB 200 receives the UE Assistance Information including the fact that the UE 100 is stopped, the eNB 200 may determine that the UE 100 is a fixed UE, and determine to include the extended DRX configuration information into the RRC Connection Release to be transmitted to the UE 100. As a result, the eNB 200 can achieve the DRX configuration for the UE in accordance with the movement state of the UE 100.

Furthermore, the eNB 200 may determine whether or not to perform (set) the Per-cell Paging, in accordance with the UE Assistance Information, transmitted from the UE 100, including the fact that the UE 100 is moving or stopped. Here, “perform (set) the Per-cell Paging” may be synonymous with determining, by the eNB 200, whether or not to transmit the paging message received from the MME 300, as described above.

Specifically, if the eNB 200 determines that the UE 100 camping on the cell managed by the eNB 200 is moving, the eNB 200 may not need to perform (set) the Per-cell Paging, and if determines that the UE 100 is stopped, the eNB 200 may perform (set) the Per-cell Paging. That is, the eNB 200 determines whether or not to perform (set) the Per-cell Paging, in accordance with the movement state of the UE 100 camping on the cell managed by the eNB 200. As a result, for example, if the eNB 200 determines that the UE being stopped does not camp on the cell managed by the eNB 200, the eNB 200 can, in the first place, save the time and effort for determining, based on the UE-ID list, whether or not to transmit the paging message by performing the normal paging, and not performing (setting) the Per-cell Paging. It is noted that “performing the normal paging” refers to transmitting, by the eNB 200, the paging message transmitted from the MME 300 in the conventional manner.

Furthermore, the eNB 200 may transmit, to the MME 300, information relating to the movement state of the UE 100 included in the UE Assistance Information transmitted from the UE 100. The MME 300 may determine whether or not to perform the Per-cell Paging in accordance with the information. Specifically, the MME 300 may determine, in accordance with the movement state of the UE 100 (moving or being stopped), which of the Per-cell Paging or the normal paging to be performed for the transmission of the paging message for the UE 100. For example, if information on the fact that the UE 100 is stopped is included in the UE Assistance Information transmitted from the UE 100, the MME 300 may determine to perform the normal paging without performing the Per-cell Paging. It is noted that the Per-cell Paging described here refers to the Per-cell Paging in the first embodiment.

### Modification of Second Embodiment

In the above-described second embodiment, the MME 300 transmits, to each of the eNBs 200, in a tracking area unit, a paging message similar to the conventional one. Meanwhile, in a modification of the second embodiment, if the MME 300 requests each of the eNBs 200 to perform the paging for the extended DRX configured UE 100 (to transmit a paging message for the extended DRX configured UE 100), the MME 300 may transmit an “MTC PAGING MESSAGE”, which is a paging message dedicated to an MTC UE and different from the conventional paging message. It is noted that the “MTC UE” is a fixed UE (UE determined to be stopped) and/or an extended DRX configured UE, for example. It is noted that the eNB 200 that has received the “MTC PAGING MESSAGE” determines whether or not an identifier of the UE included in the “MTC PAGING MESSAGE” is included in the UE-ID list in the memory 230. Then, if the eNB 200 determines that the identifier of the UE included in the “MTC PAGING MESSAGE” is included in the UE-ID list, the eNB 200 may transmit the “MTC PAGING MESSAGE”. Furthermore, if the identifier of the UE is associated with a Cell ID, the eNB 200 may transmit the “MTC PAGING MESSAGE” or a paging message, to a cell corresponding to the Cell ID.

### Other Embodiments

In the above-described embodiment, an extended DRX configured UE 100 has been described as an example; however, the present disclosure is not limited thereto. If it is a case of a paging message for the UE 100 in which the normal DRX configuration is applied, the eNBs 200 and the MME 300 may perform similar operations.

In the above-described modification, if the eNB 200-1 detects that the UE 100 has received a paging message, the eNB 200-1 may notify the MME 300 of a release message. The MME 300 that has received the release message can notify another eNB 200 of the release message, in a similar manner to the embodiment.

In the above-described embodiment, as one example of a cellular communication system, the LTE system is described; however, the present disclosure is not limited to the LTE system, and the present disclosure may be applied to systems other than the LTE system.

### INDUSTRIAL APPLICABILITY

The present disclosure is useful in the field of communication.

1. A network apparatus, comprising:
a receiver configured to receive, from a base station, information on a base station or on a cell on which a predetermined user terminal camps;
a storage configured to store the information; and
a controller configured to decide, based on the information, a base station to which a paging message is transmitted.

2. A mobile communication method, comprising the steps of:
associating, by a network apparatus, an identifier of a predetermined user terminal with an identifier of a cell on which the predetermined user terminal camps and/or an identifier of a base station managing the cell; and
transmitting, by the network apparatus, a paging message addressed to the predetermined user terminal to a base station corresponding to the identifier of the cell or the identifier of the base station associated with the identifier of the predetermined user terminal.

3. The mobile communication method according to claim 2, wherein
the predetermined user terminal is an extended DRX configured user terminal.

4. The mobile communication method according to claim 3, further comprising a step of:
applying the extended DRX, by the predetermined user terminal, based on extended DRX configuration information included in an RRC connection release message transmitted from the base station.

5. The mobile communication method according to claim 2, further comprising the steps of:
performing cell reselection, by the predetermined user terminal; and
transmitting, by the predetermined user terminal, an identifier of a cell selected by the sell reselection and/or a base station managing the cell, to the network apparatus.

6. The mobile communication method according to claim 2, further comprising a step of:
transmitting, by the base station, the identifier of the predetermined user terminal camping on a cell managed by the base station, to the network apparatus.

7. The mobile communication method according to claim 6, further comprising a step of:
transmitting, by the predetermined user terminal, the identifier of the user terminal to the base station.

8. The mobile communication method according to claim 7, further comprising the steps of:
performing cell reselection, by the predetermined user terminal; and
transmitting, by the predetermined user terminal, the identifier of the user terminal to a base station managing a cell selected by the cell reselection.

9. A mobile communication method, comprising the steps of:
storing, by a base station, an identifier of a predetermined user terminal camping on a cell managed by the base station;
receiving, by the base station, a paging message from a network apparatus;
determining, by the base station, whether an identifier of a user terminal included in the paging message matches the stored identifier of the predetermined user terminal; and
transmitting, by the base station, the paging message in response to a determination that the identifier of the user terminal included in the paging message matches the stored identifier of the predetermined user terminal.

10. The mobile communication method according to claim 9, wherein
the predetermined user terminal is an extended DRX configured user terminal.

11. The mobile communication method according to claim 9, further comprising the steps of:
determining, by the base station, based on an identifier of a user terminal included in the paging message, whether or not the user terminal camp on a cell managed by the base station; and
rejecting transmission of the paging message, by the base station, in response to a determination that the user terminal does not camp on a cell managed by the base station.

12. The mobile communication method according to claim 11, further comprising a step of:
determining, by the base station, that the user terminal does not camp on a cell managed by the base station, in response to a determination that the identifier of the user terminal included in the paging message does not match the stored identifier of the predetermined user terminal.

13. The mobile communication method according to claim 11, further comprising the steps of:
receiving, by the base station, from a neighboring base station, an identifier of a predetermined user terminal camping on a cell managed by the neighboring base station; and
determining, by the base station, that the user terminal does not camp on a cell managed by the base station, in response to a determination that the identifier of the predetermined user terminal received from the neighboring base station and the identifier of the user terminal included in the paging message are matched to each other.

14. The mobile communication method according to claim 13, further comprising the steps of:
performing cell reselection, by a user terminal,
transmitting, by the user terminal, an identifier of the user terminal to the neighboring base station that manages a cell selected by the cell reselection.

15. A network apparatus comprising:
a controller including a processor and a memory communicatively coupled to the processor, wherein the controller is configured to execute processes of:
associating an identifier of a predetermined user terminal with an identifier of a cell on which the predetermined user terminal camps and/or a base station configured to manage the cell; and
transmitting, a paging message addressed to the predetermined user terminal, to a base station corresponding to the identifier of the cell or the identifier of the base station associated with the identifier of the predetermined user terminal.

16. A base station comprising:
a controller including a processor and a memory communicatively coupled to the processor, wherein the controller is configured to execute the processes of:
receiving a paging message from a network apparatus;
determining, based on an identifier of a user terminal included in the paging message, whether the user terminal camps on a cell managed by the base station; and
rejecting transmission of the paging message, in response to a determination that the user terminal does not camp on a cell managed by the base station.

17. The mobile communication method according to claim 2, wherein the predetermined user terminal is a user terminal being stopped.
